(19) United States
(12) Patent Application Publication
(10) Pub. No.: US 2007/0024286 A1
(43) Pub. Date: Feb. 1, 2007

(54) Compensation for tool disposition in LWD resistivity measurements

(75) Inventor: Tsili Wang, Katy, TX (US)

Correspondence Address: MADAN, MOSSMAN & SRIRAM, P.C., 2603 AUGUSTA, SUITE 700, HOUSTON, TX, 77057, US

(73) Assignee: Baker Hughes Incorporated, Houston, TX (US)

(21) Appl. No.: 11/490,920

(22) Filed: Jul. 21, 2006

Related U.S. Application Data
(60) Provisional application No. 60/703,037, filed on Jul. 27, 2005.
(60) Provisional application No. 60/777,351, filed on Feb. 28, 2006.

(51) Int. Cl. G01V 3/00

(52) U.S. Cl. 324/338

(57) ABSTRACT

A logging tool having an axial transmitter antenna and a transverse receiver antenna is provided with a bucking coil that compensates for the environmental effects including tool-bending and eccentricity.

### CROSS-REFERENCES TO RELATED APPLICATIONS

This application claims priority from U.S. Provisional Patent Application Ser. No. 60/703,037 filed on 27 Jul. 2005 and from U.S. Provisional Patent Application Ser. No. 60/777351 filed on 28 Feb. 2006.

### BACKGROUND OF THE INVENTION

1. Field of the Invention

This invention relates generally to drilling of lateral wells into earth formations, and more particularly to the maintaining the wells in a desired position relative to an interface within a reservoir.

2. Description of the Related Art

To obtain hydrocarbons such as oil and gas, well boreholes are drilled by rotating a drill bit attached at a drill string end. The drill string may be a jointed rotatable pipe or a coiled tube. Boreholes may be drilled vertically, but directional drilling systems are often used for drilling boreholes deviated from vertical and/or horizontal boreholes to increase the hydrocarbon production. Modem directional drilling systems generally employ a drill string having a bottomhole assembly (BHA), and a drill bit at an end thereof, that is rotated by a drill motor (mud motor) and/or the drill string. A number of downhole devices placed in close proximity to the drill bit measure certain downhole operating parameters associated with the drill string. Such devices typically include sensors for measuring downhole temperature and pressure, tool azimuth, tool inclination. Also used are measuring devices such as a resistivity-measuring device to determine the presence of hydrocarbons and water. Additional downhole instruments, known as measurement-while-drilling (MWD) or logging-while-drilling (LWD) tools, are frequently attached to the drill string to determine formation geology and formation fluid conditions during the drilling operations.

Boreholes are usually drilled along predetermined paths and proceed through various formations. A drilling operator typically controls the surface-controlled drilling parameters during drilling operations. These parameters include weight on bit, drilling fluid flow through the drill pipe, drill string rotational speed (r.p.m. of the surface motor coupled to the drill pipe) and the density and viscosity of the drilling fluid. The downhole operating conditions continually change and the operator must react to such changes and adjust the surface-controlled parameters to properly control the drilling operations. For drilling a borehole in a virgin region, the operator typically relies on seismic survey plots, which provide a macro picture of the subsurface formations and a pre-planned borehole path. For drilling multiple boreholes in the same formation, the operator may also have information about the previously drilled boreholes in the same formation.

In development of reservoirs, it is common to drill boreholes at a specified distance from fluid contacts within the reservoir. An example of this is shown in FIG. 2 where a porous formation denoted by 105a, 105b has an oil-water contact denoted by 113. The porous formation is typically capped by a caprock such as 103 that is impermeable and may further have a non-porous interval denoted by 109 underneath. The oil-water contact is denoted by 113 with oil above the contact and water below the contact: this relative positioning occurs due to the fact the oil has a lower density than water. In reality, there may not be a sharp demarcation defining the oil-water contact; instead, there may be a transition zone with a change from high oil-saturation at the top to high water-saturation at the bottom. In other situations, it may be desirable to maintain a desired spacing from a gas-oil contact. This is depicted by 114 in FIG. 1. It should also be noted that a boundary such as 114 could, in other situations, be a gas-water contact.

In order to maximize the amount of recovered oil from such a borehole, the boreholes are commonly drilled in a substantially horizontal orientation in close proximity to the oil-water contact, but still within the oil zone. U.S. Pat. No. RE35,386 to Wu et al, having the same assignee as the present application and the contents of which are fully incorporated herein by reference, teaches a method for detecting and sensing boundaries in a formation during directional drilling so that the drilling operation can be adjusted to maintain the drillstring within a selected stratum. The method comprises the initial drilling of an offset well from which resistivity of the formation with depth is determined. This resistivity information is then modeled to provide a modeled log indicative of the response of a resistivity tool within a selected stratum in a substantially horizontal direction. A directional (e.g., horizontal) well is thereafter drilled wherein resistivity is logged in real time and compared to that of the modeled horizontal resistivity to determine the location of the drill string and thereby the borehole in the substantially horizontal stratum. From this, the direction of drilling can be corrected or adjusted so that the borehole is maintained within the desired stratum. The resistivity sensor typically comprises a transmitter and a plurality of sensors. Measurements may be made with propagation sensors that operate in the 400 kHz and higher frequency range.

A limitation of the method and apparatus used by Wu is that resistivity sensors are responsive to oil-water contacts for relatively small distances, typically no more than 5 m; at larger distances, conventional propagation tools are not responsive to the resistivity contrast between water and oil. One solution that can be used in such a case is to use an induction logging tool that typically operates in frequencies between 10 kHz and 50 kHz. U.S. Pat. No. 6,308,136 to Tabarovsky et al, having the same assignee as the present application and the contents of which are fully incorporated herein by reference, teaches a method of interpretation of induction logs in near horizontal boreholes and determining distances to boundaries in proximity to the borehole.

An alternative approach to determination of distances to bed boundaries is disclosed in U.S. patent application Ser. No. 10/373,365 of Merchant et al. Taught therein is the use of multicomponent induction logging tools and measurements as an indicator of a distance to a bed boundary and altering the drilling direction based on such measurements. In conventional induction logging tools, the transmitter and receiver antenna coils have axes substantially parallel to the tool axis (and the borehole). The antenna configuration of the multicomponent tool of Merchant et al, is illustrated in FIG. 3.

FIG. 3 (prior art) shows the configuration of transmitter and receiver coils in the 3DExplorer™ (3DEX) induction logging instrument of Baker Hughes Incorporated. Three orthogonal transmitters 201, 203, and 205 that are referred to as the Tₓ, T_{z}, and T_{y}transmitters respectively are provided. The three transmitters 201, 203, 205 induce magnetic fields in three spatial directions. The subscripts (x, y, z) indicate an orthogonal system substantially defined by the directions of the normal to the coils of the transmitters. The z-axis is chosen to be along the longitudinal axis of the tool, while the x-axis and y-axis are mutually perpendicular directions lying in the plane transverse to the axis. Corresponding to each transmitter 201, 203, and 205 are associated receivers 207, 209, and 211, referred to as the Rₓ, R_{z}, and R_{y} receivers respectively, aligned along the orthogonal system defined by the transmitter normals, placed in the order shown in FIG. 3. Rₓ, R_{z}, and R_{y} are responsible for measuring the corresponding magnetic fields Hₓₓ, H_{zz}, and H_{yy}. Within this system for naming the magnetic fields, the first index indicates the direction of the transmitter and the second index indicates the direction of the receiver. In addition, the receivers R_{y} and R_{z}, measure two cross-components, H_{xy} and H_{xz}, of the magnetic field produced by the Tₓ transmitter (201). This embodiment is operable in single frequency or multiple frequency modes. It should further be noted that the description herein with the orthogonal coils and one of the axes parallel to the tool axis is for illustrative purposes only. Additional components could be measured, and, in particular, the coils could be inclined at an angle other than 0° or 90° to the tool axis, and furthermore, need not be orthogonal; as long as the measurements can be “rotated” or “projected” onto three orthogonal axes, the methodology described herein is applicable. Measurements may also be made at a plurality of frequencies, and/or at a plurality of transmitter-receiver distances.

While the teachings of Merchant show that the 3DEX measurements are very useful in determination of distances to bed boundaries (and in reservoir navigation), Merchant discusses the reservoir navigation problem in terms of measurements made with the borehole in a substantially horizontal configuration (parallel to the bed boundary). This may not always be the case in field applications where the borehole is approaching the bed boundary at an angle. In a situation where the borehole is inclined, then the multicomponent measurements, particularly the cross-component measurements, are responsive to both the distance to the bed boundary and to the anisotropy in the formation.

It would be desirable to have a method of determination of distance to a bed boundary in a deviated well in anisotropic earth formations. The present invention satisfies this need.

### SUMMARY OF THE INVENTION

One embodiment of the invention is an apparatus for evaluating an earth formation. The apparatus includes a logging tool conveyed in a borehole. The tool has a transmitter coil having a first direction and a receiver coil which has a second direction different from the first direction. The receiver coil produces a signal resulting from activation of the transmitter. An additional coil arrangement on the logging tool has an output which is used to reduce an environmental effect on the signal resulting from a disposition of the logging tool in the borehole. The disposition may include a bending of the logging tool. The disposition may include the tool being in a non-circular borehole, an eccentric position of the logging tool in the borehole, a non-circular borehole and/or eccentric positioning of the tool in an invaded zone. The additional coil arrangement may include a coil having an axis substantially parallel to the second direction. The second direction may be substantially orthogonal to the first direction. The output of the additional coil arrangement may be combined with the signal from the receiver coil. The apparatus may include a processor which accumulates the signal from the receiver coil and the output of the additional coil arrangement and combines the two accumulated outputs. The first direction may be substantially parallel to a longitudinal axis of the tool. The apparatus may further include a processor which uses the signal and the output to estimate a distance to an interface in the earth formation. The logging tool may be on a bottomhole assembly and the apparatus may include a processor which uses the signal and the output to control a direction of drilling of the BHA.

Another embodiment of the invention is a method of evaluating an earth formation. A signal is produced using a receiver coil on a logging tool in response to activation of a transmitter coil on the logging tool, the two coils having different directions. An output of an additional coil arrangement is used to reduce an environmental effect on the signal resulting from disposition of the logging tool in the borehole. The logging tool may be bent. The logging tool may be positioned in a non-circular borehole, eccentrically positioned in a circular borehole, positioned in a borehole having a non-circular invasion zone and/or positioned in a borehole having an eccentric invasion zone. The additional coil may be oriented in a direction substantially parallel to the direction of the receiver coil. The receiver coil may be oriented substantially orthogonal to the transmitter coil. The outputs of the additional coil arrangement may be combined with the signal from the receiver. The signal from the receiver coil may be accumulated and combined with the accumulated output of the additional coil arrangement. The transmitter coil may be oriented substantially parallel to a longitudinal axis of the logging tool. The signal and the output may be used to estimate a distance to an interface in the earth formation. The logging tool may be conveyed on a BHA and the direction of drilling of the BHA may be controlled using the signal and the output.

### BRIEF DESCRIPTION OF THE DRAWINGS

For a detailed understanding of the present invention, reference should be made to the following detailed description of the exemplary embodiments, taken in conjunction with the accompanying drawings, in which like elements have been given like numerals and wherein:

FIG. 1 shows a schematic diagram of a drilling system having a drill string that includes a sensor system according to the present invention;

FIG. 2 is an illustration of a substantially horizontal borehole proximate to an oil-water contact in a reservoir;

FIG. 3 (prior art) illustrates the 3DEX™ multi-component induction tool of Baker Hughes Incorporated;

FIG. 4 illustrates the transmitter and receiver configuration of a logging-while-drilling tool according to the present invention;

FIG. 5 illustrates the use of bucking coils with the tool illustrated in FIG. 4;

FIGS. 6a, 6b show exemplary responses of the tool of FIG. 4 to a resistive bed above a conductive bed, and a conductive bed above a resistive bed respectively;

FIGS. 7a and 7c show the effect of tool eccentricity on the response of the logging tool of FIG. 4;

FIGS. 7b and 7d show the effects of tool eccentricity on the response of the logging tool of FIG. 5;

FIG. 8a and 8b show the effect of tool bending on azimuthal resistivity measurements; and

FIG. 8c shows the results of using the bucking coils in the presence of tool bending.

### DETAILED DESCRIPTION OF EXEMPLARY EMBODIMENTS

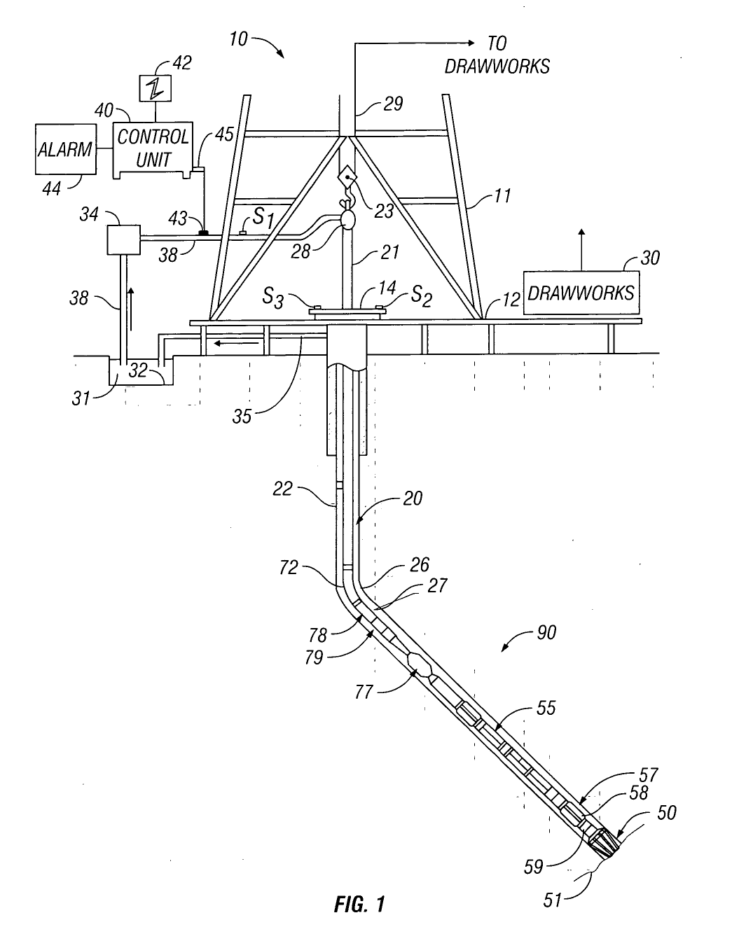

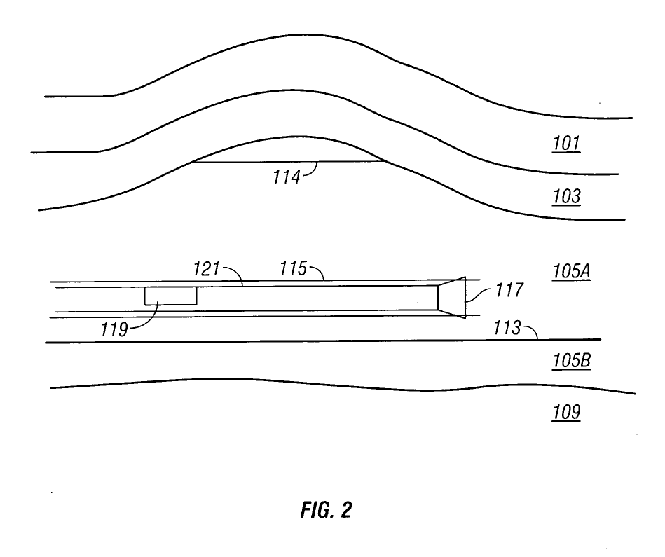

FIG. 1 shows a schematic diagram of a drilling system 10 with a drillstring 20 carrying a drilling assembly 90 (also referred to as the bottomhole assembly, or “BHA”) conveyed in a “wellbore” or “borehole” 26 for drilling the wellbore. The drilling system 10 includes a conventional derrick 11 erected on a floor 12 which supports a rotary table 14 that is rotated by a prime mover such as an electric motor (not shown) at a desired rotational speed. The drillstring 20 includes a tubing such as a drill pipe 22 or a coiled-tubing extending downward from the surface into the borehole 26. The drillstring 20 is pushed into the wellbore 26 when a drill pipe 22 is used as the tubing. For coiled-tubing applications, a tubing injector, such as an injector (not shown), however, is used to move the tubing from a source thereof, such as a reel (not shown), to the wellbore 26. The drill bit 50 attached to the end of the drillstring breaks up the geological formations when it is rotated to drill the borehole 26. If a drill pipe 22 is used, the drillstring 20 is coupled to a drawworks 30 via a Kelly joint 21, swivel 28, and line 29 through a pulley 23. During drilling operations, the drawworks 30 is operated to control the weight on bit, which is an important parameter that affects the rate of penetration. The operation of the drawworks is well known in the art and is thus not described in detail herein.

During drilling operations, a suitable drilling fluid 31 from a mud pit (source) 32 is circulated under pressure through a channel in the drillstring 20 by a mud pump 34. The drilling fluid passes from the mud pump 34 into the drillstring 20 via a desurger (not shown), fluid line 38 and Kelly joint 21. The drilling fluid 31 is discharged at the borehole bottom 51 through an opening in the drill bit 50. The drilling fluid 31 circulates uphole through the annular space 27 between the drillstring 20 and the borehole 26 and returns to the mud pit 32 via a return line 35. The drilling fluid acts to lubricate the drill bit 50 and to carry borehole cutting or chips away from the drill bit 50. A sensor S₁ typically placed in the line 38 provides information about the fluid flow rate. A surface torque sensor S₂ and a sensor S₃ associated with the drillstring 20 respectively provide information about the torque and rotational speed of the drillstring. Additionally, a sensor (not shown) associated with line 29 is used to provide the hook load of the drillstring 20.

In one embodiment of the invention, the drill bit 50 is rotated by only rotating the drill pipe 22. In another embodiment of the invention, a downhole motor 55 (mud motor) is disposed in the drilling assembly 90 to rotate the drill bit 50 and the drill pipe 22 is rotated usually to supplement the rotational power, if required, and to effect changes in the drilling direction.

In an exemplary embodiment of FIG. 1, the mud motor 55 is coupled to the drill bit 50 via a drive shaft (not shown) disposed in a bearing assembly 57. The mud motor rotates the drill bit 50 when the drilling fluid 31 passes through the mud motor 55 under pressure. The bearing assembly 57 supports the radial and axial forces of the drill bit. A stabilizer 58 coupled to the bearing assembly 57 acts as a centralizer for the lowermost portion of the mud motor assembly.

In one embodiment of the invention, a drilling sensor module 59 is placed near the drill bit 50. The drilling sensor module contains sensors, circuitry and processing software and algorithms relating to the dynamic drilling parameters. Such parameters typically include bit bounce, stick-slip of the drilling assembly, backward rotation, torque, shocks, borehole and annulus pressure, acceleration measurements and other measurements of the drill bit condition. A suitable telemetry or communication sub 72 using, for example, two-way telemetry, is also provided as illustrated in the drilling assembly 90. The drilling sensor module processes the sensor information and transmits it to the surface control unit 40 via the telemetry system 72.

The communication sub 72, a power unit 78 and an MWD tool 79 are all connected in tandem with the drillstring 20. Flex subs, for example, are used in connecting the MWD tool 79 in the drilling assembly 90. Such subs and tools form the bottom hole drilling assembly 90 between the drillstring 20 and the drill bit 50. The drilling assembly 90 makes various measurements including the pulsed nuclear magnetic resonance measurements while the borehole 26 is being drilled. The communication sub 72 obtains the signals and measurements and transfers the signals, using two-way telemetry, for example, to be processed on the surface. Alternatively, the signals can be processed using a downhole processor in the drilling assembly 90.

The surface control unit or processor 40 also receives signals from other downhole sensors and devices and signals from sensors S₁-S₃ and other sensors used in the system 10 and processes such signals according to programmed instructions provided to the surface control unit 40. The surface control unit 40 displays desired drilling parameters and other information on a display/monitor 42 utilized by an operator to control the drilling operations. The surface control unit 40 typically includes a computer or a microprocessor-based processing system, memory for storing programs or models and data, a recorder for recording data, and other peripherals. The control unit 40 is typically adapted to activate alarms 44 when certain unsafe or undesirable operating conditions occur. The BHA also includes an azimuthal resistivity tool described in more detail below. I

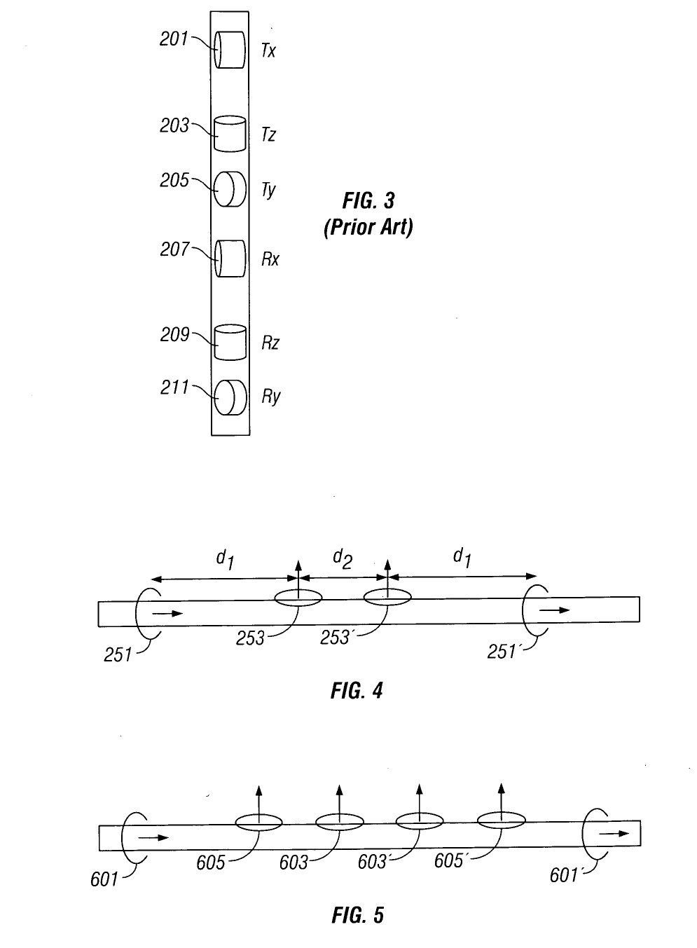

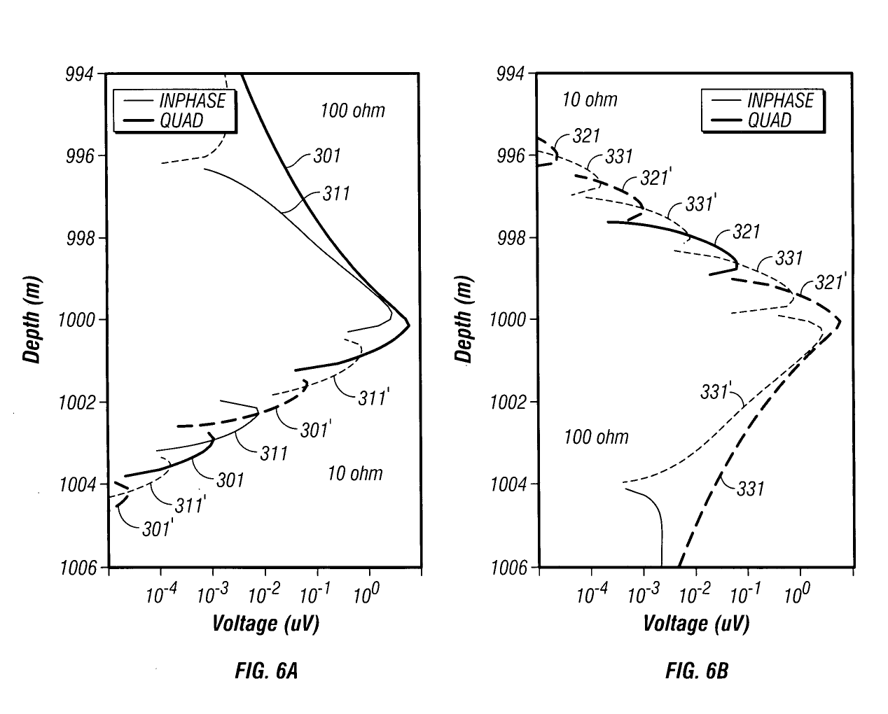

FIG. 4 shows an azimuthal resistivity tool configuration suitable for use with various embodiments of the present invention. This is a modification of the basic 3DEX tool of FIG. 3 and comprises two transmitters 251, 251′ whose dipole moments are parallel to the tool axis direction and two receivers 253, 253′ that are perpendicular to the transmitter direction. In one embodiment of the invention, the tool operates at 400 kHz frequency. When the first transmitter fires, the two receivers measure the magnetic field produced by the induced current in the formation. This is repeated for, the second transmitter. The signals are combined in following way:
H_{T1}=H₂−(d₁/(d₁+d₂))³·H₁
H_{T2}=H₁−(d₁/(d₁+d₂))³·H₂ (1).
Here, H₁ and H₂ are the measurements from the first and second receivers, respectively, and the distances d₁ and d₂ are as indicated in FIG. 4. The tool rotates with the BHA and in an exemplary mode of operation, makes measurements at 16 angular orientations 22.5° apart. The measurement point is at the center of the two receivers. In a uniform, isotropic formation, no signal would be detected at either of the two receivers. The invention thus makes use of cross-component measurements, called principal cross-components, obtained from a pair of transmitters disposed on either side of at least one receiver. It should further be noted that using well known rotation of coordinates, the method of the present invention also works with various combinations of measurements as long as they (i) correspond to signals generated from opposite sides of a receiver, and, (ii) can be rotated to give the principal cross-components.

The dual transmitter configuration was originally developed to reduce electronic errors in the instrument and to increase the signal to noise ratio. See U.S. Pat. No. 6,586,939 to Fanini et al. The use of the configuration of FIG. 4 is discussed in detail in U.S. patent application Ser. No. 11/298,255 of Yu et al., having the same assignee as the present invention and the contents of which are incorporated herein by reference. The response of a cross-component receiver is sensitive to the direction of a bed boundary near the logging tool. When the transmitter and receiver coils are perfectly aligned, i.e., mutually orthogonal, the direct coupling between them will be zero. The only contribution then comes from the remote bed that can be approximated with a mirror image of the transmitter coil. If the remote bed is conductive, the mirror transmitter will have the same moment direction as the real transmitter. This also is true if the remote bed is below the transmitter.

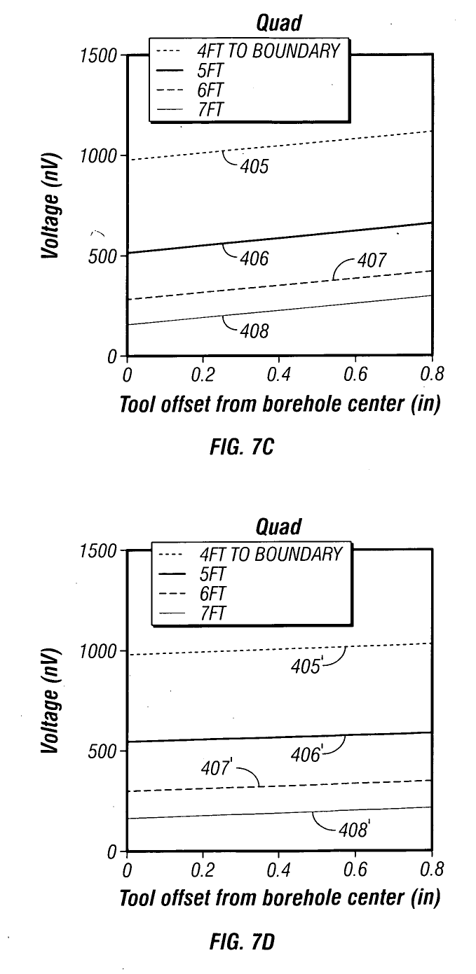

In what follows, the invention is described with reference to a single transmitter antenna and a single receiver antenna. FIG. 6a shows the tool response at different distances from a bed boundary for an exemplary model. The response corresponds to a signal at a transverse receiver antenna in response to excitation of an axially oriented transmitter coil. The abscissa is the signal in μV and the ordinate is the tool depth. The model includes a layer of resistivity 100 Ω-m above a bed of resistivity 1 Ω-m. The boundary between the two layers is at the depth indicated by 1000 m. The curves 301, 301′ are the quadrature component of the induced magnetic field at the receiver, i.e., the component that has a phase of 90° relative to the transmitter signal. The segments 301 have a positive polarity while the segments 301′ have a negative polarity. The curves 311, 311′ are the in-phase component of the induced magnetic field at the receiver. Again, the segments 311′ have a negative polarity relative to the segments 311.

FIG. 6b shows the tool response at different distances from a bed boundary for another exemplary model. The model differs from the model of FIG. 6a in that the layer of resistivity 100 Ω-m is below a bed of resistivity 1 Ω-m. The interface is again at the depth indicated by 1000 m. The curves 321, 321′ are the quadrature component of the induced magnetic field at the receiver, i.e., the component that has a phase of 90° relative to the transmitter signal. The segments 321 have a positive polarity while the segments 321′ have a negative polarity. The curves 331, 331′ are the in-phase component of the induced magnetic field at the receiver. Again, the segments 331′ have a negative polarity relative to the segments 331.

As can be seen, the responses above 1000 m in FIG. 6a are the mirror images of those in FIG. 6b below 1000 m. The quadrature component has simpler characteristics than the in-phase component in that the former has the same sign as the tool crosses the boundary. This property makes the quadrature component more useful for data interpretation.

Like other resistivity measurements, the azimuthal resistivity tool is subject to various environmental effects. The primary ones are (1) an eccentricity effect, (2) a temperature effect, and (3) a tool bending effect. Here, the term “eccentric” encompasses both the dictionary definitions of the word, i.e., deviating from a circularity (for the borehole), or located elsewhere than at the geometrical center. The measurement accuracy is sensitive to fluctuations in downhole temperatures in single transmitter systems. The tool bending effect can introduce strong direct coupling into the measurement, particularly in wells with high build-up or drop-down angles. To remove or suppress all the environmental effects, a bucking-coil system has been included in the present invention. The bucking coil works as in wireline array induction tools. Use of bucking coils removes all fields that decay as 1/r³, where r is the receiver spacing.

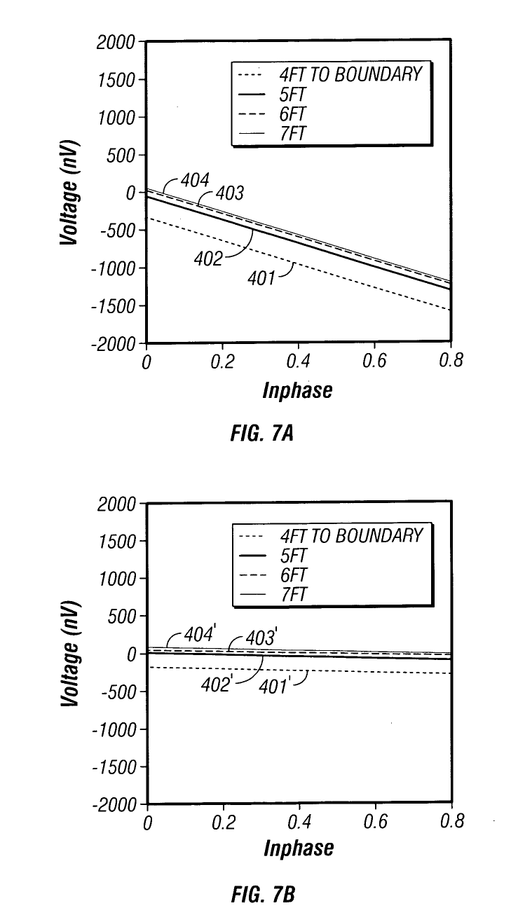

Turning now to FIG. 5, a modification of the tool of FIG. 4 that has been developed to address environmental effects is shown. As in FIG. 4, there are two transmitter antennas 601, 601′ and two receiver antennas 603, 603′. The bucking coils (antennas) 605, 605 ′ are positioned between the corresponding transmitter and receiver antennas. The bucking coils 605, 605′ have axes that are substantially parallel to the axes of the receiver antennas 603, 603′. The bucking coil will thus see the same tool-bending effect and eccentering effect as the receiver antenna.

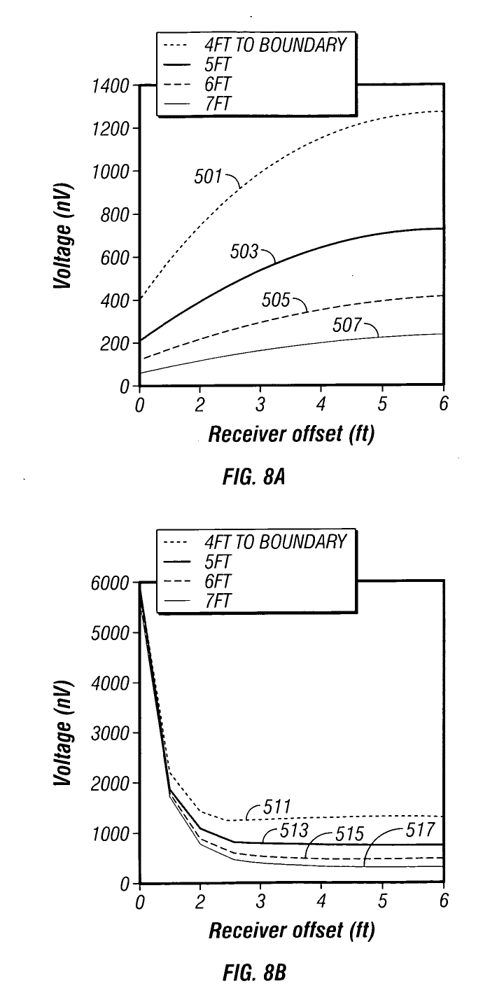

To illustrate the magnitude of the effect of eccentering of the tool, model simulations using a finite-difference method were carried out. The tool outer diameter was taken as 6.75 in (0.171 m). The borehole diameter was taken as 8.5 in (.216 m). The borehole fluid resistivity was 1000 Ω-m. FIG. 7a shows the in-phase components 401, 402, 403, 404 for four different distances (from the top 7 ft., 6 ft., 5 ft. and 4 ft.; or 2.134 m, 1.829 m, 1.524 m and 1.219 m) without the bucking coils. The ordinate is the signal in nV and the abscissa is the tool eccentering in inches. FIG. 7b shows the in-phase signal 401′, 402′, 403′, 404′ when bucking coils are used.

FIG. 7c shows the quadrature components 405, 406, 407, 408 for the four different distances (4 ft., 5 ft., 6 ft. and 7 ft.; or 1.219 m, 1.524 m, 1.829 m, and 2.134 m) without the bucking coils. The ordinate is the signal in nV and the abscissa is the tool eccentering in inches. FIG. 7d shows the quadrature signal 405′, 406′, 407′, 408′ when bucking coils are used.

FIGS. 7a and 7c shows that both in-phase and quadrature components can be severely distorted by tool eccentricity, especially when the tool is far from the bed boundary. Note that the percentage variation in 408 (7 ft. or 2.134 m distance) over the range of eccentering is much greater than the percentage variation in 405 (4 ft. or 1.219 m distance) over the same range of eccentering. As seen in the relatively flat behavior of the curves in FIG. 7b and 7d, the effect on the in-phase component and the quadrature component of the signals due to the eccentering is substantially eliminated. As noted above, the eccentering could be due to decentralization of the tool in a circular borehole as well as due to a non-circular borehole. Thus, the measurements made by the tool can be used to estimate a parameter of interest of the earth formation such as a distance to an interface (such as a bed-boundary) in the earth formation.

There is a simple explanation for the reduction in eccentricity effects with a bucking coil system. The effect of an eccentric tool can be approximated by an image transmitter placed symmetrically with respect to the borehole wall. Because of the proximity of the image transmitter to the tool axis, the response decays roughly as 1/r³. Therefore, the image transmitter response can be bucked the same way as for the direct coupling. It should be noted that similar benefits accrue when the tool of the present invention is used in a borehole with a non-circular invasion zone, or when the tool is positioned off center in an invaded zone of a borehole.

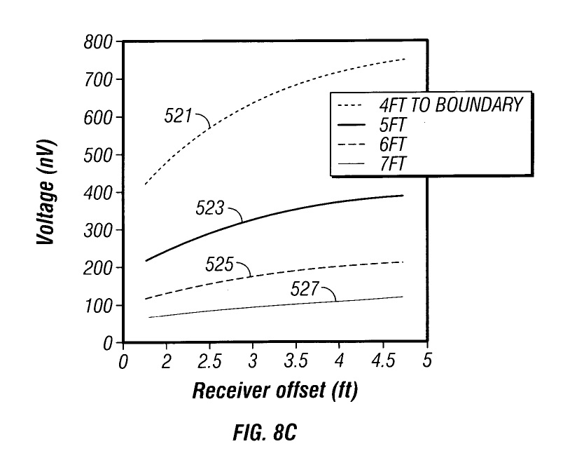

The tool bending effect can be more severe for the azimuthal resistivity tool than for a conventional, coaxial tool. The reason for this is that tool bending introduces direct coupling between the transmitter and receiver antennas, whereas a coaxial coil tool is relatively insensitive to tool bending. A strong direct coupling may destroy the sign reversal property of the azimuthal measurement as mentioned earlier. A bent tool will produce coplanar and/or coaxial coupling. The field produced by both types of coupling in the air falls as 1/r³. In view of the 1/r³ decay, it is recognized by the inventors that bucking can be effective to cancel the effect of tool bending. This is verified in FIGS. 8a, 8b, and 8c.

Simulation results were obtained for a tool bent at 4°/100 ft (1.3°/10 m). FIG. 8a shows the responses 501, 503, 505, 507 at distances of (4 ft., 5 ft., 6 ft. and 7 ft.; or 1.219 m, 1.524 m, 1,829 m and 2.134 m) respectively as a function of transmitter-receiver offset in feet for a tool with no bending. FIG. 8b shows the responses 511, 513, 515, 517 when the tool is bent. The differences between the curves of FIG. 8b and those of FIG. 8a are dramatic, and indicate that the tool performance would be seriously degraded at 4°/100 ft (1.3°/10 m). FIG. 8c shows the results when the bucking coil arrangement of FIG. 5 is used. The curves 521, 523, 525, 527 differ little from 501, 503, 505, 507 for the straight tool without bucking coils. Again, using the apparatus of the present invention, it is possible to determine a distance to a bed boundary in the presence of tool-bending.

The environmental effects discussed above result from a non-ideal disposition of the logging tool in the borehole, i.e., if the condition of a straight tool positioned in the center of a circular borehole is not satisfied.

It should be noted that the signals from the (main) receiver antenna may be combined with the signals from the corresponding bucking coil by analog or digital circuitry to accomplish the cancellation of the undesired signal. In an alternative embodiment of the invention, signals measured by the bucking coil and the receiver antenna are digitally accumulated (stacked) prior to the cancellation.

Once the distance to the interface has been determined, the processor may control the direction of drilling of the BHA. Alternatively, a real-time display may be provided to a human operator to alter the direction of drilling. The usual objective in such is reservoir navigation

The processing of the data may be done by a downhole processor to give corrected measurements substantially in real time. Alternatively, the measurements could be recorded downhole, retrieved when the drillstring is tripped, and processed using a surface processor. Implicit in the control and processing of the data is the use of a computer program on a suitable machine-readable medium that enables the processor to perform the control and processing. The machine-readable medium may include ROMs, EAROMs, EPROMs, EEPROMs, Flash Memories, and Optical disks.

The foregoing description is directed to particular embodiments of the present invention for the purpose of illustration and explanation. It will be apparent, however, to one skilled in the art having the benefit of the present disclosure that many modifications and changes to the embodiments set forth above are possible without departing from the scope and the spirit of the invention. It is intended that the following claims be interpreted to embrace all such modifications and changes.

The scope of the invention may be better understood with reference to the following definitions:
anisotropic: exhibiting properties with different values when measured in different directions;
coil: one or more turns, possibly rectangular, circular or cylindrical, of a conductor capable of (i) producing a magnetic field when a current is passed through, or (ii) producing a current in the presence of a time-varying magnetic field;
EAROM: electrically alterable ROM;
eccentering: deviating from circularity and/or being located elsewhere than at the geometric center;
EEPROM: EEPROM is a special type of PROM that can be erased by exposing it to an electrical charge.
EPROM: erasable programmable ROM;
flash memory: a nonvolatile memory that is rewritable;
horizontal resistivity: resistivity in a direction normal to an axis of anisotropy, usually in a direction parallel to a bedding plane of an earth formation;
induction: the induction of an electromotive force in a circuit by varying the magnetic flux linked with the circuit.
machine-readable medium: something on which information may be stored in a form that can be understood by a computer or a processor;
Optical disk: a disc-shaped medium in which optical methods are used for storing and retrieving information;
Principal cross-component: a signal obtained by excitation with a longitudinal transmitter coil in a transverse receiver coil or by excitation with a transverse transmitter coil in a longitudinal receiver coil;
Quadrature: 90° out of phase;
ROM: Read-only memory; and
vertical resistivity: resistivity in a direction parallel to an axis of anisotropy, usually in a direction normal to a bedding plane of an earth formation

What is claimed is:

1. An apparatus for evaluating of an earth formation, the apparatus comprising:
(a) a logging tool conveyed in a borehole, the tool having:
(A) a transmitter coil having a first direction;
(B) a receiver coil having a second direction different from the first direction, the receiver coil producing a signal resulting from activation of the transmitter;
(b) an additional coil arrangement an output of which is used to reduce an environmental effect on the signal resulting from a disposition of the logging tool in the borehole.

2. The apparatus of claim 1 wherein the disposition of the tool comprises a bending of the logging tool.

3. The apparatus of claim 1 wherein the disposition comprises at least one of (i) the tool being in non-circular borehole, (ii) an eccentric position of the logging tool in the borehole, (iii) a non-circular invasion zone, and (iv) an eccentric invasion zone.

4. The apparatus of claim 1 wherein the additional coil arrangement further comprises a coil having an axis substantially parallel to the second direction.

5. The apparatus of claim 1 wherein the second direction is substantially orthogonal to the first direction.

6. The apparatus of claim 1 wherein the output of the additional coil arrangement is combined with the signal from the receiver coil.

7. The apparatus of claim 1 further comprising a processor which:
(i) accumulates the signal from the receiver coil and the output of the additional coil arrangement, and
(ii) combines the accumulated signal and the accumulate output.

8. The apparatus of claim 1 wherein the first direction is substantially parallel to a longitudinal axis of the logging tool.

9. The apparatus of claim 1 further comprising a processor which uses the signal and the output to estimate a distance to an interface in the earth formation.

10. The apparatus of claim 1 wherein the logging tool is on a bottomhole assembly (BHA), the apparatus further comprising a processor which uses the signal and the output to control a direction of drilling of the BHA.

11. A method of evaluating an earth formation, the method comprising:
(a) activating a transmitter coil having a first direction on a logging conveyed in a borehole in the earth formation;
(b) producing a signal responsive to the activation of the transmitter coil using a receiver coil on the logging tool, the receiver coil having a second direction different from the first direction, and
(c) using an output of an additional coil arrangement to reduce an environmental effect on the signal resulting from a disposition of the logging tool in the borehole.

12. The method of claim 11 further comprising having a bending in the logging tool.

13. The method of claim 11 further comprising positioning the logging tool in one of (i) a non-circular borehole, (ii) an eccentric position in a circular borehole, (iii) a borehole having a non-circular invasion zone, and (iv) a borehole having an eccentric invasion zone.

14. The method of claim 11 further comprising orienting the additional coil arrangement in a direction substantially parallel to the second direction.

15. The method of claim 11 further comprising orienting the receiver coil in a direction substantially orthogonal to the first direction.

16. The method of claim 11 wherein reducing the effect further comprises combining the output of the additional coil arrangement with the signal from the receiver coil.

17. The method of claim 11 further comprising:
(i) accumulating the signal from the receiver coil and the output of the additional coil arrangement, and
(ii) combining the accumulated signal and the accumulate output.

18. The method of claim 11 further comprising orienting the transmitter coil in a direction that is substantially parallel to a longitudinal axis of the logging tool.

19. The method of claim 11 further comprising using the signal and the output to estimate a distance to an interface in the earth formation.

20. The method of claim 11 further comprising conveying the logging tool on a bottomhole assembly (BHA), and using the signal and the output to control a direction of drilling of the BHA.
